(19) United States
(12) Patent Application Publication
(10) Pub. No.: US 2015/0296159 A1
(43) Pub. Date: Oct. 15, 2015

(54) Image Sensors Comprising Hybrid Arrays of Global and Rolling Shutter Pixels

(71) Applicant: Forza Silicon Corporation, Pasadena, CA (US)

(72) Inventors: Barmak Mansoorian, La Canada Flintridge, CA (US); Liviu Oniciuc, South Pasadena, CA (US)

(21) Appl. No.: 14/684,404

(22) Filed: Apr. 12, 2015

Related U.S. Application Data
(60) Provisional application No. 61/978,860, filed on Apr. 12, 2014.

(51) Int. Cl. H04N 5/374; H04N 5/3745

(52) U.S. Cl. CPC H04N 5/374; H04N 5/37455

(57) ABSTRACT

Provided herein are novel hybrid sensor arrays comprising both global and rolling shutter pixels. The hybrid pixel arrays of the invention can be made predominantly of inexpensive rolling shutter pixels, augmented with smaller number of global shutter pixels. Data from the global shutter pixels can be used in various ways, for example, to rectify rolling shutter artifacts captured by the majority of the pixels in the array. These novel designs and associated methods advantageously enable the correction of rolling shutter artifacts while retaining the advantages of rolling shutter pixel cost and ease of manufacture.

### CROSS-REFERENCE TO RELATED APPLICATIONS

This application claims the benefit of priority to U.S. Provisional Application Ser. No. 61/978,860 entitled “Hybrid Image Sensor Arrays,” filed Apr. 12, 2014, the contents of which are hereby incorporated by reference.

### REFERENCE TO SEQUENCE LISTING, A TABLE, OR A COMPUTER PROGRAM LISTING COMPACT DISK APPENDIX

Not Applicable.

### STATEMENT REGARDING FEDERALLY SPONSORED RESEARCH OR DEVELOPMENT

Not Applicable.

### BACKGROUND OF THE INVENTION

CMOS image sensor comprising rolling shutter designs are commonly used in dedicated cameras and camera-equipped devices such as smartphones, tablet computers, laptops, etc. In rolling shutter pixel arrays, the pixels in each row are sequentially read out and reset, such that pixel readout occurs in a repeating, “rolling” pattern, typically from the top to the bottom of the pixel array. Accordingly, the integration period of pixels in different rows of a rolling shutter array are not simultaneous. This creates various artifacts in the resulting image when there is camera movement, movement of objects within the image, or rapidly changing light conditions, because the light flux measurement by pixels in the upper rows are attained sooner than those attained by the lower rows of pixels. Broadly referred to as “rolling shutter artifact,” various types of geometrical distortion including wobble, shear, and skew are encountered in images captured by rolling shutter pixel arrays.

One approach to the problem of rolling shutter artifact is the use of computational rectification methods to analyze images, identify distortions, and recreate the image with the distortions corrected. A large number of such rectification methods are known in the art. One class of rectification models relies on utilizing sensors to track the motion of the camera at the time of image acquisition in order to derive correction factors to rectify the image. This approach requires additional hardware elements, must account for measurement errors by the movement sensors, and fails to correct for motion artifacts caused by moving subjects within the frame. Another class of rectification methods are those which computationally infer the movement of the camera and/or objects within the frame by detecting global and local distortions and applying appropriate correction factors. These methodologies are generally computationally expensive, as intensive and complex modeling is required in order to derive predicted relative positions of objects and features within the frame. Many of these methods are also applicable only for the correction of video images, as they require serial images in order to interpolate feature positions, which precludes their application in the correction of still frames. Another limitation of these computational approaches is that the resulting corrections are themselves a source of visual artifacts.

Rolling shutter designs, although prone to these artifacts and the limitations of suboptimal correction schemes, can advantageously utilize relatively inexpensive pixel designs, such as 4T pixel designs, as known in the art. Accordingly, rolling shutter pixel designs remain in common use due to their economical manufacturing. Rolling shutter pixels also have the advantage of generally low power consumption, relative to more complex pixel designs.

The artifacts inherent in a rolling shutter pixel array can be avoided by the use of global shutter designs. In a global shutter pixel array, the pixels in all rows are simultaneously reset and charge integration is simultaneous in all pixels. In global shutter arrays, the integration period of each pixel is coordinated such that photodiode reset and signal charge collection is performed simultaneously in each pixel, with synchronized transfer of accumulated charge to an in-pixel storage means (for example, a sample-and-hold circuit), for subsequent sequential readout of the rows in a serial fashion similar to that for rolling shutter. Because the light from the entire frame is captured simultaneously, motion or changing light artifacts are substantially eliminated using global shutter pixel designs. However, global shutter designs are complex, requiring additional circuitry for the storing and readout of signals as well as requiring shielding structures to minimize current noise caused by incident light. Global pixel designs having six, eight, or even ten transistors are common, as opposed to the four transistors of a modern CMOS pixel in a rolling shutter array. The complexity of global shutter designs results in expensive manufacturing costs. Additionally, these arrays have higher power consumption rates than simpler pixel circuits used in rolling shutter designs.

The rolling and global shutter pixel arrays known in the art are homogeneous, comprising either rolling shutter pixels, global shutter pixels, or, in some cases, a switchable pixel that can operate in either rolling or global shutter mode. These standard homogeneous arrays are disadvantageously constrained by the limitations of the single pixel type of which they are made, for example the expense of manufacture, power consumption, or limits on resolution.

Accordingly, there is a need in the art for solutions which avoid the shortcomings of rolling shutter artifacts, suboptimal computational artifact rectification methods, and the expense of implementing global shutter arrays. The inventions disclosed herein provide the art with novel solutions in the form of hybrid arrays of rolling shutter pixels and global shutter pixels. These novel devices and methods capitalize on the advantages of rolling shutter and global shutter pixel attributes while minimizing their disadvantages.

### SUMMARY OF THE INVENTION

Disclosed herein are novel hybrid sensor arrays comprising both global and rolling shutter pixels. The hybrid pixel arrays of the invention can be made predominantly of inexpensive rolling shutter pixels, augmented with smaller number of global shutter pixels. Data from the global shutter pixels can be used to rectify rolling shutter artifacts captured by the majority of the pixels in the array. These novel designs and associated methods advantageously enable the correction of rolling shutter artifacts while retaining the advantages of rolling shutter pixel cost and ease of manufacture.

### BRIEF DESCRIPTION OF THE DRAWINGS

FIG. 1A, FIG. 1B, FIG. 1C, and FIG. 1D. FIG. 1A depicts a hybrid array of the invention wherein a single island of global shutter pixels is present in an array of rolling shutter pixels. FIG. 1B depicts a hybrid array of the invention wherein a vertical stripe of global shutter pixels is present on the periphery of an array of rolling shutter pixels. FIG. 1C depicts a configuration of four islands of global shutter pixels located around the center of a rolling shutter pixel array. FIG. 1D depicts a rolling shutter pixel array wherein islands of global shutter pixels are distributed throughout the entire array.

FIG. 2. FIG. 2 depicts a subset of pixels within a hybrid array of the invention wherein an island of four global shutter pixels of larger size are surrounded by rolling shutter pixels of a smaller size.

FIG. 3A, FIG. 3B, and FIG. 3C. FIG. 3A depicts a simulated image of a moving vehicle taken with a global shutter pixel array. FIG. 3B depicts a simulated image of a moving vehicle taken with a rolling shutter pixel array. FIG. 3C depicts an image of a moving vehicle taken with a hybrid pixel array of the invention, wherein islands of global shutter pixels are interspersed in a rolling shutter pixel array.

FIG. 4A, 4B, and 4C. FIG. 4A depicts an overview of the operational timing phases in an exemplary hybrid pixel array comprising both rolling shutter and global shutter pixels. FIG. 4B depicts the timing and control scheme for the start of integration processes in a hybrid pixel array. FIG. 4C depicts the timing and control scheme for the end of integration processes in a hybrid pixel array.

### DETAILED DESCRIPTION OF THE INVENTION

The invention comprises hybrid pixel arrays wherein global and rolling shutter pixel types are intermixed. The hybrid arrays may be arranged in various patterns, as described below. The invention further encompasses methods of processing data from the hybrid arrays, wherein the information captured by global shutter pixels is utilized to identify and rectify any rolling shutter artifacts in the portion of the image captured by the rolling shutter pixels. The hybrid array may advantageously utilize low-cost rolling shutter pixels for the majority of the array while intermixed or strategically placed global shutter pixels capture undistorted image information. The resulting image, referred to herein as a “hybrid image,” contains undistorted portions captured by the global shutter pixels which provide real (as opposed to computationally modeled) reference points which simplify and improve image rectification methods.

As used herein, “rolling shutter pixel” will refer to a pixel configured for use in an array having a sequential row integration, reset, and readout scheme, as known in the art. Exemplary rolling shutter pixels include 3T and 4T designs, as known in the art, which are utilized in typical rolling shutter array designs. As used herein, “global shutter pixel” will refer to a pixel configured for synchronized integration and reset with like pixels present in the same array. Global shutter pixels have an in-pixel memory component (e.g. a sample-and-hold circuit) for storing integrated charge, and are capable of synchronization with other global shutter pixels such that they simultaneously reset and integrate charge from incident light.

Control signal and pixel output lines (e.g. column buses), as well as output signal processing components (e.g. ADC elements), may be partially shared among rolling and global shutter pixels within the hybrid array, or each type of pixel may have its own dedicated lines and output processing means. Where feasible, the sharing of control and readout components between the different pixel types in the array is desirable in order to increase array fill factor and to simplify manufacturing. Filter and microlens arrays (e.g. Bayer arrays), may be made as known in the art and subsequently aligned and placed over the hybrid array. For example, image data captured by global shutter pixels may have higher noise (e.g. read noise). The hybrid arrays of the invention may be implemented wherein the global shutter pixels are not covered by a color filter, in order to improve their sensitivity, while the rolling shutter pixels (for example in a 3:1 ratio to global shutter pixels) can be covered in standard color filter arrays, resulting in an RGBW type color filter arrangement. This would ensure that the global shutter pixels see features in all parts of the spectrum.

The timing of pixel operation for each pixel type in the hybrid array may be synchronized, for example in order to enable the use of shared control signals, output lines, and signal processing means. Alternatively, the two arrays may operate on totally different timing regimes. The global shutter pixels of the hybrid arrays may be synchronized with any row of the hybrid array. In one embodiment, the global shutter pixel store and reset signals are timed to be simultaneous with the charge transfer (e.g. opening of the transfer gate in a 4T pixel) signal and the reset signals, respectively, of the rolling shutter pixels in the very top or very bottom row of the hybrid array. This results in a hybrid image wherein the integration period of the global shutter pixels is substantially aligned with timing of the top-to-bottom row scan for the rolling shutter pixels in the array.

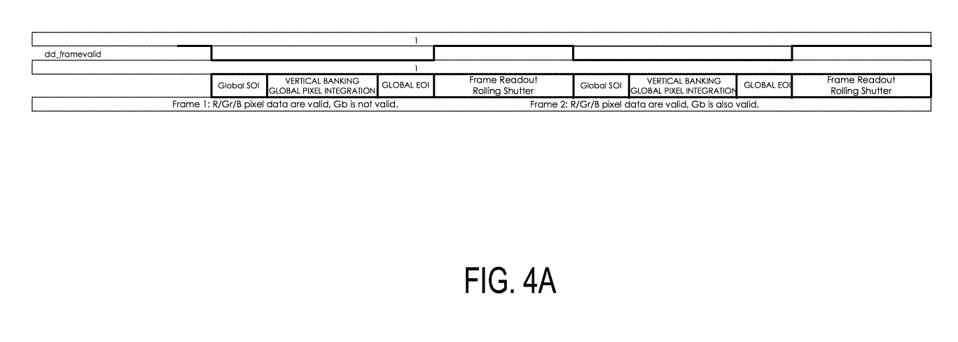

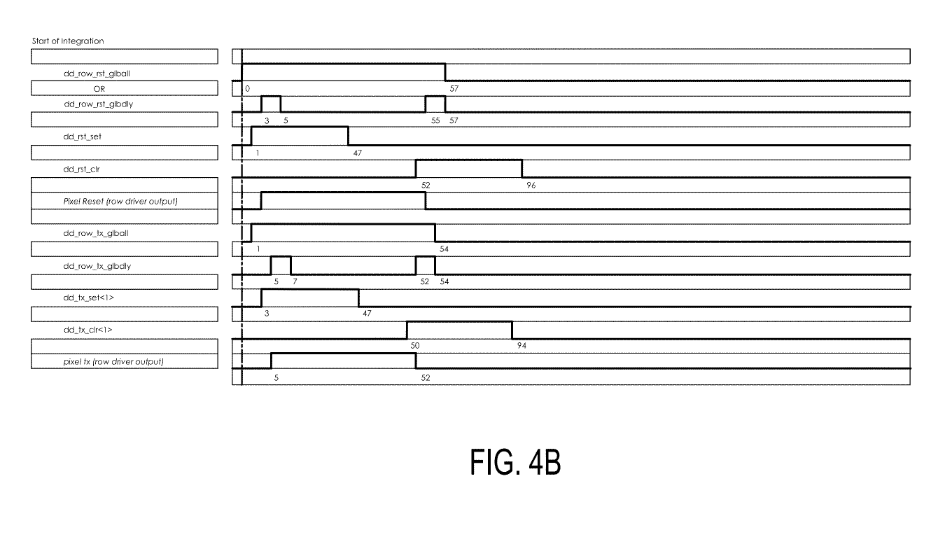

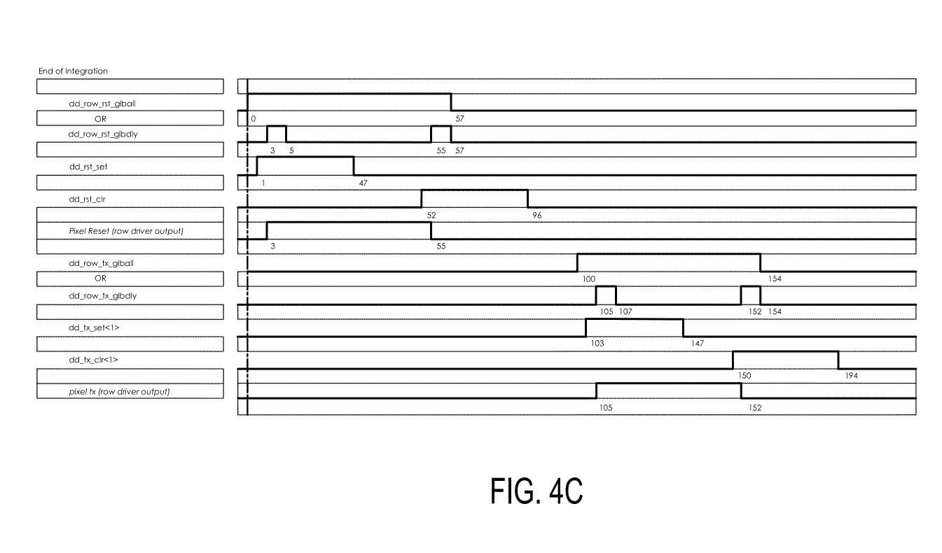

Timing and control signals for an exemplary implementation of the hybrid pixel array of the invention are depicted in FIG. 4A, FIG. 4B, and FIG. 4C.

The relative proportions of rolling shutter pixels and global shutter pixels in the hybrid array may vary. In general, implementations of the invention wherein at least 50% or more of the pixels comprise rolling shutter pixels will be desirable, as such pixels are less complex and expensive to manufacture and operate with lower power consumption. For example, hybrid arrays comprising at least 50%, 55%, 60%, 65%, 70%, 75%, 80%, 85%, 90%, or 95% rolling shutter pixels may be used. In alternative embodiments, a minority of the pixels may be rolling shutter pixels.

Any distribution of global shutter pixels and rolling shutter pixels in the hybrid array may be utilized. Because rolling shutter artifacts are typically a product of top-to-bottom row scanning, in some embodiments it will be advantageous to create vertical arrangements of global shutter pixels to provide comparative image data from the top and bottom portions of the image. In some embodiments, the global shutter pixels are evenly intermixed in regular patterns throughout the hybrid array. For example, in one embodiment, the hybrid array comprises a repeating block of four pixels, arranged in a 2 by 2 pixel square, wherein one pixel is a global shutter pixel and the remaining three are rolling shutter pixels. In another embodiment, alternating vertical columns of rolling shutter and global shutter pixels are utilized. In another embodiment, every third or fourth vertical column of pixels in the hybrid array comprises a column of global shutter pixels. In alternative implementations, horizontal rows of global shutter pixels may be utilized, for example every second, third, or fourth row can comprise a row of global shutter pixels.

In another implementation of the invention, the global shutter pixels may be present in discreet patches, herein referred to as “islands.” The size of the islands may vary, for example being only a few pixels in size to many thousands of pixels. The shape of the islands may vary as well, being oblong, square, circular, or substantially linear. Substantially square or rectangular islands are preferred in some embodiments wherein the global and rolling shutter pixels are served by separate control and output lines, in order to minimize the number and footprint of duplicative control and output lines.

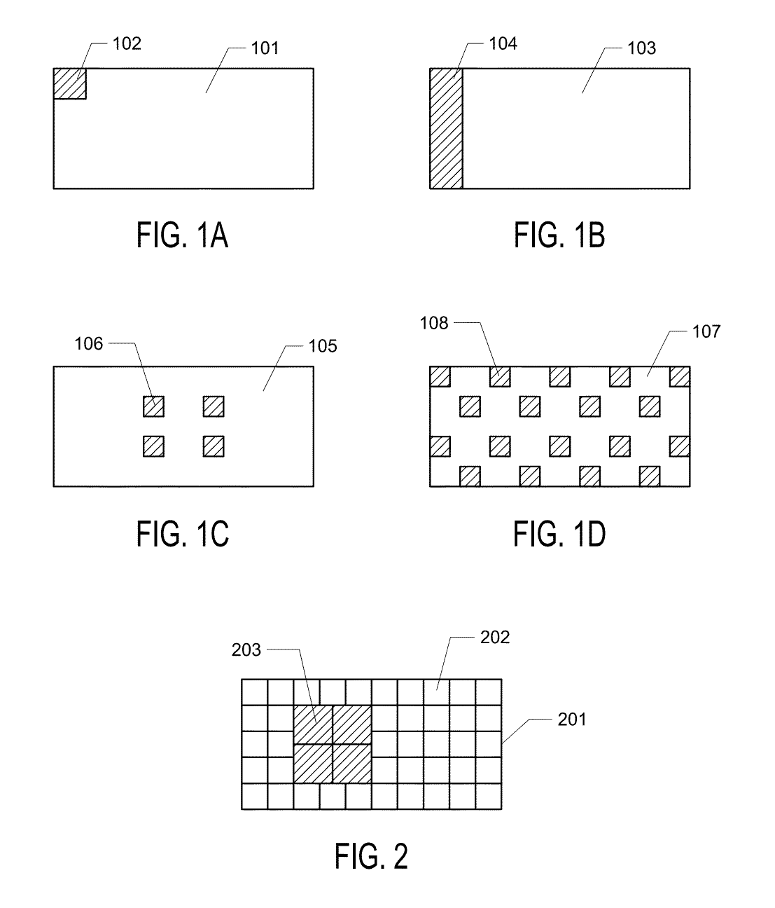

In some situations, global movement of the camera during image acquisition results in rolling shutter artifacts throughout the image. In such cases, a hybrid sensor comprising a minimal number of global shutter pixel islands (e.g. a single island) can effectively be used to create a hybrid image capable of rectification by the methods herein, so long as the area of the image captured by the single island contains sufficient feature detail to allow calculation of global camera movement by comparison with regions captured by rolling shutter pixels. In such cases, the island can be localized to the edge of the image sensor array, which advantageously simplifies manufacturing requirements and avoids the presence of overlapping control and readout bus lines within the rolling shutter portion of the array. Additionally, since the peripheral portions of the image are typically not the focus of the viewer and may be cropped out, any artifacts caused by differential color/exposure between global and rolling shutter pixels will be less intrusive to the viewer. FIG. 1A depicts a rolling shutter pixel array (101) wherein a single square shaped island of global shutter pixels (102) is present at the corner of the array. FIG. 1B depicts a rolling shutter pixel array (103) wherein a vertical patch of global shutter pixels (104) is located on the border of the pixel array. When utilizing such peripheral global shutter islands, e.g. horizontal or vertical strips, the image data from these global shutter pixels optionally may be omitted from the final image but can be included as metadata in the image file for subsequent rectification operations.

In contrast, where it is the movement of subject objects within the frame of the image that creates rolling shutter artifacts, it will be necessary to insure that some portion of the moving object is imaged by the global shutter pixels, allowing comparison with regions of the image captured by rolling shutter pixels. Arrays comprising regular patterns of intermixed global shutter pixels throughout the frame, as described above, may be advantageously used in such cases, as every portion of the frame will include some image data captured by global shutter pixels. Alternatively, islands of global shutter pixels may be used. For example, assuming the camera is typically aimed at or centered on moving subjects, objects in motion can be partially imaged using a small number islands, as depicted in FIG. 1C, wherein a small number of islands (106) is arranged at or around the center of the rolling shutter pixel array (105). Alternatively, a pattern of islands which substantially addresses all regions of the frame may be used in order to increase the probability of capturing with global shutter pixels a portion of any moving objects or features that require image rectification, for example as depicted in FIG. 1D.

In some embodiments, the global and rolling shutter pixels will be of the same size and/or the same shape. However, it will be understood that global shutter pixels and rolling shutter pixels may be of different sizes and/or shapes. For example, global shutter pixels are in some cases larger than rolling shutter pixels due to the need for shielded areas of the storage node, which reduces fill factor. Pixels of heterogeneous size can be arranged in regular patterns, for example as depicted in FIG. 2, so as to preserve the X-Y grid architecture of the array. In some cases, the global shutter pixels maybe smaller. For example, in one embodiment, four larger rolling shutter pixels in a Bayer pattern surround a smaller global shutter pixel. This arrangement may be useful in applications auch as high-end DSLR's or military night vision sensors.

Switchable Pixel Arrays. Switchable pixel arrays are known in the art, comprising a single pixel type which may operate in either a rolling shutter or global shutter read and output mode. For example, the VITA 5000™ by Onsemi, or the Neo 5.5™ (by Andor) are CMOS image sensors that are capable of operation in both global and rolling shutter mode. As an improvement to such existing systems, the scope of the invention encompasses novel methods of configuring and operating switchable pixel arrays. The improvement of the invention comprises the rewiring of control signal lines and output lines in switchable pixel arrays such that selected regions within the switchable pixels arrays may be configured to operate in different modes, so that some pixels are operating as rolling shutter pixels while others are simultaneously operating in global shutter mode. Due to the full switchability of each pixel, different interspersed patterns and configurations of global and rolling shutter operation may be enabled, with patterns being selectively optimized for the type of photography being performed. In this way, the hybrid pixel arrays of the invention may be functionally recreated in an array of switchable pixels.

Image Files. It will be understood by one of skill in the art that the output of the hybrid pixel arrays of the invention are image files. Image files comprise image data captured by some or all of the pixels in the hybrid array, stored in a non-transitory computer readable medium. Exemplary image files include image files in Raw, JPEG, TIFF, PNG, AVI, Mov, MP4 and other types of still or video image file formats known in the art.

In some embodiments, the output image files comprise image data from only one type of pixel present in the hybrid array, i.e. only rolling shutter pixel data or only global shutter pixel data. For example, in one embodiment, the image is captured in a mode wherein the control signals are selected such that only the rolling shutter pixels or the global shutter pixels present in the array are activated during image capture. The resulting image data is limited to that generated by the pixel type selected for activation. In alternative embodiments, image data is captured by both types of pixels, but the image data from one type of pixel (i.e. rolling shutter pixel or global shutter pixel) is omitted in the final image file.

Image Reconstruction. The image files produced by the hybrid array will typically contain a mix of data from both global shutter and rolling shutter pixels. The portions of the image captured by global shutter pixels will generally be undistorted or less distorted than those captured by rolling shutter pixels, even if movement of the camera and/or objects within the frame has caused rolling shutter artifacts in those portions of the image captured by rolling shutter pixels. This undistorted image data captured by global shutter pixels can be used to aid in the computational rectification of the rolling shutter artifacts present in the rest of the image.

Various computational operations may be performed on the image files created using the hybrid devices of the invention. It will be evident to one of skill in the art that such operations are performed in a computer environment, for example, by a general purpose processor, utilizing software which comprises instructions stored on a non-transitory computer readable medium. The performance of such computational operations may be carried out by any number of image data analysis tools known in the art, and may be performed “on-chip” by processor elements present on the image sensor device, or may be performed post-hoc on data exported from the image sensor to external memory and/or processor elements, by general purpose computer processor elements or specialized processing hardware and software.

Advantageously, image data captured by global shutter pixels can increase the accuracy of and reduce the computational intensity of image rectification methodologies. By providing a true, undistorted region of the image as a reference point, rectification algorithms can readily identify the nature of rolling shutter artifacts (e.g. wobble, shear, skew), calculate movement vectors responsible for the artifacts, and accurately calculate the appropriate correction factors to apply to the distorted portions of the image. Computationally expensive processes for recreating the proper perspective are simplified or obviated by the presence of undistorted image features which anchor the reconstructions in one or more actual reference points, as opposed to computationally-inferred reference points.

In one embodiment, a rolling shutter artifact detection step is performed (by data analysis tools comprising hardware and/or software elements capable of performing such operations) on image data captured by a hybrid pixel array, wherein the image file is analyzed to detect rolling shutter artifacts, including localized artifacts (e.g. a moving object in the image) or global artifacts (e.g. camera movement). Such rolling shutter artifact detection processes may optionally utilize image data captured by global shutter pixels within the image.

In another embodiment, a rectification step is performed (by image rectification tools comprising hardware and/or software elements capable of performing such operations) wherein detected rolling shutter artifacts are rectified. Such rolling shutter artifact rectification processes may optionally utilize image data captured by global shutter pixels within the image. The end product of the detection and rectification processes is an image file comprising a rectified image, wherein rolling shutter artifacts have been reduced or eliminated.

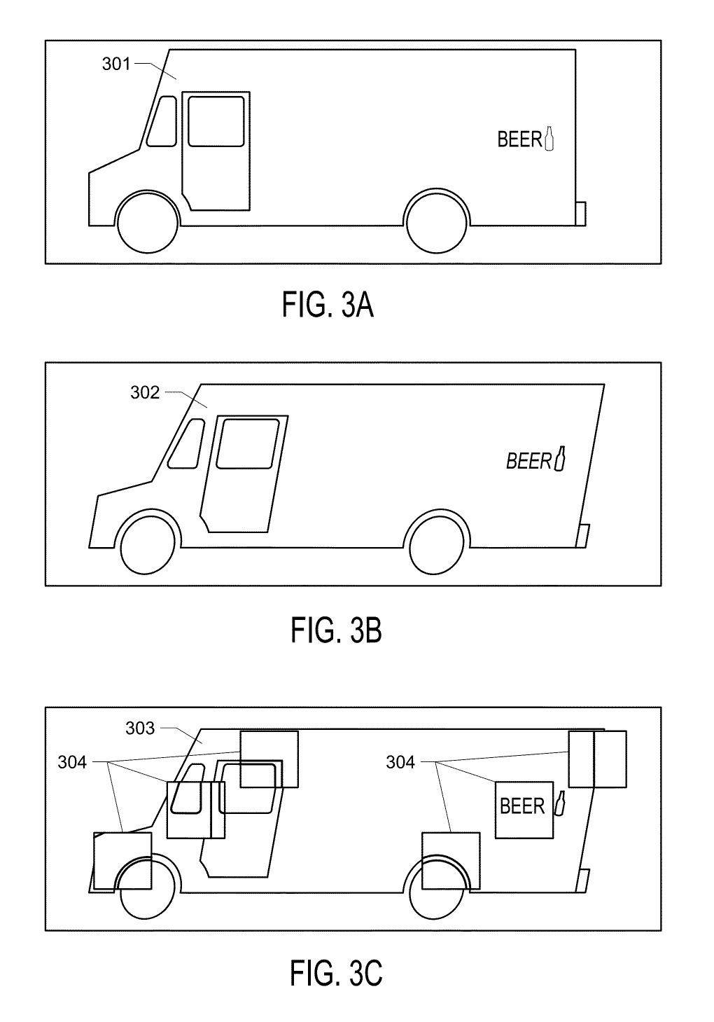

Illustrative simulated images are presented in FIG. 3A, FIG. 3B, and FIG. 3C. FIG. 3A is a simulated image of a moving delivery truck captured by an image sensor comprising an array of global shutter pixels. The truck (301) appears undistorted in the image. FIG. 3B is a simulated image of the same moving delivery truck captured with an array of rolling shutter pixels. Because of the top-to-bottom scanning of the pixel rows in this image sensor, the moving vehicle (302) appears distorted, with a pronounced skew. FIG. 3C is a simulated image of the moving delivery truck captured with a hybrid pixel array of the invention. In this exemplary implementation, the array comprises a majority of rolling shutter pixels, wherein six global shutter islands (304) are arranged in two diagonal rows. The majority of the moving object (303) is captured by rolling shutter pixels and is distorted as in FIG. 3B. However, within the islands of global shutter pixels (304), the object is not distorted and its true proportions are captured. While using only a small fraction of expensive global shutter pixels in the array, these undistorted islands provide a means of accurately detecting rolling shutter artifact caused by movement of the truck and rectification of the image utilizing the image data captured by the global shutter pixels, creating a rectified image, wherein the entire image will appear substantially undistorted as in FIG. 3A.

Any number of rectification methodologies known in the art may be adapted to the methods of the invention. For example, methods that determine global camera movements may be modified for use in the methods of the invention, for example as described in: Baker et al., “Removing rolling shutter wobble,” in IEEE CVPR, 2010; Meingast et al., “Geometric models of rolling shutter cameras,” Proc. of the 6th Workshop on Omnidirectional Vision, Camera Networks and Non-Classical Cameras, 2005; or Forssen et al., “Rectifying rolling shutter video from handheld devices,” in IEEE CVPR, 2010. Likewise, the rectification of hybrid images can be aided by methodologies that rely on feature extraction and tracking, such as those described in: Ait-Aider et al., “Exploiting rolling shutter distortions for simultaneous object pose and velocity computation using a single view,” in ICVS, page 35, 2006; and Heflin et al., “Correcting rolling-shutter distortion of CMOS sensors using facial feature detection, in Biometrics: Theory Applications and Systems,” (BTAS), 2010 Fourth IEEE International Conference on Biometrics Compendium, IEEE. Additionally, rolling shutter correction technologies that rely on optical flow analysis using subsequent frames in a video file may be adapted for use in the rectification methods of the invention, for example those described in Bradley et al., “Synchronization and rolling shutter compensation for consumer video camera arrays,” in IEEE CVPR Workshops, pages 1-8, 2009 or Chun et al., “Suppressing rolling-shutter distortion of cmos image sensors by motion vector detection,” IEEE Transactions on Consumer Electronics, 54(4):14791487, 2008.

As with prior art rectification methods, supplementary information may be used in the rectification process, such as data from adjoining frames in a video file or camera movement data acquired by gyroscopes or other motion detection elements.

In some embodiments, the image rectification methods of the invention are utilized for post-hoc removal of rolling shutter artifacts from previously acquired images. In other embodiments, the methods are applied in real time to enable accurate feature tracking, for example as applied in facial tracking or machine vision applications.

Because global and rolling shutter pixels may have different performance characteristics, the color and exposure of image portions captured by each pixel type in the hybrid array may vary. Accordingly, it may be necessary to apply color/exposure correction algorithms, as known in the art, to hybrid images in order to smooth or remove artifacts visible at the interfaces between the two pixel types.

Applications of the Invention. In one aspect, the scope of the invention encompasses the hybrid pixel array devices described herein. The scope of the invention further encompasses devices which incorporate such hybrid pixel arrays, for example handheld personal devices such as smartphones or tablets, as well as still cameras, video cameras, etc.

In another aspect, the invention comprises methods of capturing images with hybrid arrays of the invention. In another aspect, the invention comprises methods of creating images, comprising the capture of an image using a hybrid pixel array and subsequently performing image rectification to detect and remove rolling shutter artifacts utilizing image data captured by global shutter pixels within the hybrid pixel array.

The scope of the invention further encompasses the capture of images using the hybrid pixel arrays of the invention and the subsequent and rectification of rolling shutter artifacts in such images in specific contexts. In one embodiment, the invention comprises the application of the devices and methods of the invention to correct for camera movement artifacts. In another embodiment, the invention comprises the application of the devices and methods of the invention to correct for the distortion of moving objects in images. In another embodiment, the invention comprises the application of the devices and methods of the invention in biometric applications, wherein an identifying structure of an individual is imaged and computationally analyzed for identifying features. For example, imaging of the iris of the eye for biometric identification of individuals requires a sufficiently high resolution, undistorted imaging so that minute features of the iris may be mapped. Such imaging is not possible using prior art image sensors comprising rolling shutter pixel arrays, for example as found in relatively inexpensive devices such as smartphones or tablet computers due to rolling shutter distortions. Using the hybrid pixel arrays and associated methods of the invention, inexpensive hybrid pixel arrays may be utilized for accurate creation of undistorted images, extending the ability to perform biometric applications to devices such as smartphones or tablet computers. For example, in one implementation, the invention comprises a device comprising a hybrid pixel array image sensor residing in the camera of a device. When the device is utilized for general photography, the rolling shutter pixel data is used (and optionally the global shutter pixel data may be used as well). When the device is used for biometric identification applications (for example, to unlock the device for use by its owner or authorized users), only the global shutter pixel data is used, or a rectified image utilizing both global shutter pixel and rolling shutter pixel data is used.

In another example, the hybrid pixel arrays of the invention may be utilized wherein the global shutter pixels capture data that is used for depth-of-field sensing. For example, some cameras known in the art comprise two arrays of pixels, one comprising a global shutter array and one comprising a rolling shutter array, wherein the global shutter array captures data that is used in depth-of-field analysis, for example as in the Intel RealSense 3D™ camera. The hybrid arrays of the invention could be used to replicate the functions of such prior art cameras while using a single array instead of two separate arrays.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

What is claimed is:

1. A hybrid pixel array comprising
rolling shutter pixels and global shutter pixels.

2. The hybrid pixel array of claim 1, wherein
greater than 50% of the pixels in the array are rolling shutter pixels.

3. The hybrid pixel array of claim 1, wherein
at least 75% of the pixels in the array are rolling shutter pixels.

4. The hybrid pixel array of claim 3, wherein
the array is comprised of a repeating series of blocks, wherein each block comprises a specific pattern of rolling shutter and global shutter pixels.

5. The hybrid pixel array of claim 4, wherein
the repeating blocks comprises of four pixels arranged in a two-by-two pixel square, wherein three of the pixels are rolling shutter pixels and the fourth pixel is a global shutter pixel.

6. The hybrid pixel array of claim 1, wherein
the global shutter pixels are present in one or more discreet patches.

7. The hybrid pixel array of claim 6, wherein
the one or more discreet patches comprise at least 100 pixels.

8. The hybrid pixel array of claim 6, wherein
the one or more discreet patches of global shutter pixels are located on the periphery of the array.

9. The hybrid pixel array of claim 6, wherein
the one or more discreet patches of global shutter pixels comprise a vertical stripe running substantially from the top to the bottom of the array.

10. A method of creating an image, comprising
capturing the image with a hybrid pixel array comprising both rolling shutter and global shutter pixels.

11. The method of claim 10, comprising the additional steps of
analyzing the captured image and identifying global or localized rolling shutter artifacts; and
applying rolling shutter artifact rectification tools to rectify detected rolling shutter artifacts.

12. The method of claim 11, wherein
the analysis of the image for the identification of rolling shutter artifact is performed by computational tools which compare image data captured by the rolling shutter pixels with image data captured by the global shutter pixels.

13. The method of claim 11, wherein
the rectification of detected rolling shutter artifact is performed by computational tools which utilize image data captured by the global shutter pixels to generate corrective steps to rectify the image.

14. The method of claim 11, wherein
the detection and/or rectification processes detect and/or rectify rolling shutter artifacts generated by camera movement.

15. The method of claim 11, wherein
the detection and/or rectification processes detect and/or rectify rolling shutter artifacts generated by the motion of one or more imaged objects.

16. The method of claim 10, wherein
the resulting image comprises only image data captured by the global shutter pixels.

17. The method of claim 10, wherein
the image data captured by the global shutter pixels is used for depth-of-field analysis.

18. A method of performing biometric identification, comprising
capturing an image of an identifying feature using a hybrid image sensor comprising both rolling shutter and global shutter pixels.

19. The method of claim 18, wherein
the identifying structure is the iris of an eye.
